(19) United States
(12) Patent Application Publication
(10) Pub. No.: US 2026/0264525 A1
(43) Pub. Date: Sep. 10, 2026

(54) SMOKE SUPPRESSION STRUCTURE FOR ENERGY STORAGE DEVICE

(71) Applicant: TOYOTA JIDOSHA KABUSHIKI KAISHA, Toyota-shi (JP)

(72) Inventor: Koichi NAMAI, Nisshin-shi (JP)

(73) Assignee: TOYOTA JIDOSHA KABUSHIKI KAISHA, Toyota-shi (JP)

(21) Appl. No.: 19/419,664

(22) Filed: Dec. 15, 2025

(30) Foreign Application Priority Data
Mar. 4, 2025 (JP) 2025-033561

(51) Int. Cl. B60L 3/00; B60L 50/64; H01M 50/24; H01M 50/249

(52) U.S. Cl. CPC B60L 3/0046; B60L 50/64; H01M 50/24; H01M 50/249; H01M 2220/20

(57) ABSTRACT

A smoke suppression structure for an energy storage device includes: a seat frame that constitutes a part of a vehicle; a battery pack provided below the seat frame; a fire-resistant sheet fixed to the seat frame and provided above the battery pack; and a fixing member that fixes the fire-resistant sheet to the seat frame. The fixing member is configured to release the fire-resistant sheet from the seat frame when a predetermined load is input to the vehicle.

### CROSS-REFERENCE TO RELATED APPLICATION

This application claims priority to Japanese Patent Application No. 2025-033561 filed on March 4, 2025. The disclosure of the above-identified application, including the specification, drawings, and claims, is incorporated by reference herein in its entirety.

### BACKGROUND

### Technical Field

The present disclosure relates to smoke suppression structure for energy storage devices.

### Description of Related Art

Japanese Unexamined Patent Application Publication No. 2007-200880 (JP 2007-200880 A) discloses a battery pack including: a battery module including a plurality of unit cells electrically connected to each other; a bottom plate on which the battery module is placed; and an outer case that covers the battery module. JP 2007-200880 A discloses that the outer case is provided with a fire safety device, and when the temperature of the battery module rises to a critical level, an extinguishing agent is sprayed from the fire safety device.

### SUMMARY

An energy storage device mounted on a vehicle may be installed in a non-sealed space such as a space provided below a seat frame. In such a case, even when an extinguishing agent is sprayed onto the energy storage device as in the fire safety device disclosed in JP 2007-200880 A, it is still difficult to block air from reaching the energy storage device.

The present disclosure has been made in view of the above circumstances, and an object thereof is to provide a smoke suppression structure for an energy storage device that can more easily block oxygen from reaching the energy storage device and can therefore improve the safety of the energy storage device.

A smoke suppression structure for an energy storage device according to a first aspect includes: a vehicle structural component that constitutes a part of a vehicle; an energy storage device provided below the vehicle structural component; a fire-resistant sheet fixed to the vehicle structural component and provided above the energy storage device; and a fixing member that fixes the fire-resistant sheet to the vehicle structural component. The fixing member is configured to release the fire-resistant sheet from the vehicle structural component when a predetermined load is input to the vehicle.

In the smoke suppression structure according to the first aspect, the fixing member that fixes the fire-resistant sheet releases the fire-resistant sheet when a predetermined load is input to the vehicle. Accordingly, when a load is input to the vehicle, for example in the event of a vehicle collision, the fire-resistant sheet is released and drops downward. Since the fire-resistant sheet is provided above the energy storage device, the fire-resistant sheet that has dropped covers the energy storage device from above. Therefore, when a load is input to the vehicle, the fire-resistant sheet covers the energy storage device and blocks the flow of oxygen toward the energy storage device. As a result, when a load is input to the vehicle, generation of smoke or the like from the energy storage device can be suppressed, and the safety of the energy storage device can be improved.

In a smoke suppression structure for an energy storage device according to a second aspect, in the first aspect, the smoke suppression structure further includes: a load detection unit configured to detect a load input to the vehicle; and a control unit configured to control the fixing member to release the fire-resistant sheet from the vehicle structural component based on the load detected by the load detection unit.

In the smoke suppression structure according to the second aspect, in the first aspect, the smoke suppression structure includes the control unit configured to control the fixing member to release the fire-resistant sheet based on the load detected by the load detection unit. Accordingly, when a predetermined load is input to the vehicle, the fixing member can release the fire-resistant sheet.

A smoke suppression structure for an energy storage device according to a third aspect includes: a vehicle structural component that constitutes a part of a vehicle; an energy storage device provided below the vehicle structural component; a fire-resistant sheet fixed to the vehicle structural component and provided above the energy storage device; and a fixing member that fixes the fire-resistant sheet to the vehicle structural component. The fixing member is configured to release the fire-resistant sheet from the vehicle structural component when the fixing member reaches a predetermined temperature or higher.

The smoke suppression structure according to the third aspect includes: the vehicle structural component that constitutes a part of a vehicle; the energy storage device provided below the vehicle structural component; the fire-resistant sheet fixed to the vehicle structural component and provided above the energy storage device; and the fixing member that fixes the fire-resistant sheet to the vehicle structural component. The fixing member is configured to release the fire-resistant sheet from the vehicle structural component when the fixing member reaches a predetermined temperature or higher.

In the smoke suppression structure according to the third aspect, the fixing member that fixes the fire-resistant sheet releases the fire-resistant sheet when the fixing member reaches a predetermined temperature or higher. For example, when the energy storage device generates smoke, the smoke generated from the energy storage device rises and comes into contact with the fixing member. When the smoke comes into contact with the fixing member, the temperature of the fixing member rises. When the fixing member reaches the predetermined temperature or higher, the fixing member releases the fire-resistant sheet, and the fire-resistant sheet drops downward. Since the fire-resistant sheet is provided above the energy storage device, the fire-resistant sheet that has dropped covers the energy storage device from above. Therefore, the fire-resistant sheet covers the energy storage device and blocks the flow of oxygen toward the energy storage device. Accordingly, even when the energy storage device generates smoke, generation of smoke or the like can be suppressed by the fire-resistant sheet, and the safety of the energy storage device can be improved.

In a smoke suppression structure for an electric storage device according to a fourth aspect, in any one of the first to third aspects, the fire-resistant sheet is a shape memory sheet that has a memorized shape corresponding to the external shape of the energy storage device.

In the smoke suppression structure according to the fourth aspect, the fire-resistant sheet is a shape memory sheet that has a memorized shape corresponding to the external shape of the energy storage device. Accordingly, the fire-resistant sheet can easily cover the energy storage device. Therefore, oxygen can be more easily blocked from reaching the energy storage device, and the safety of the energy storage device can further be improved.

As described above, the smoke suppression structure for an energy storage device according to the present disclosure can easily block oxygen from reaching the energy storage device and can improve the safety of the energy storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle to which a smoke suppression structure for a battery pack according to an embodiment of the present disclosure is applied;

FIG. 2 is a schematic diagram of the smoke suppression structure according to the embodiment of the present disclosure, showing a state in which a fire-resistant sheet is fixed to a seat frame; and

FIG. 3 is a schematic diagram of the smoke suppression structure according to the embodiment of the present disclosure, showing a state in which the fire-resistant sheet covers the battery pack.

### DETAILED DESCRIPTION OF EMBODIMENTS

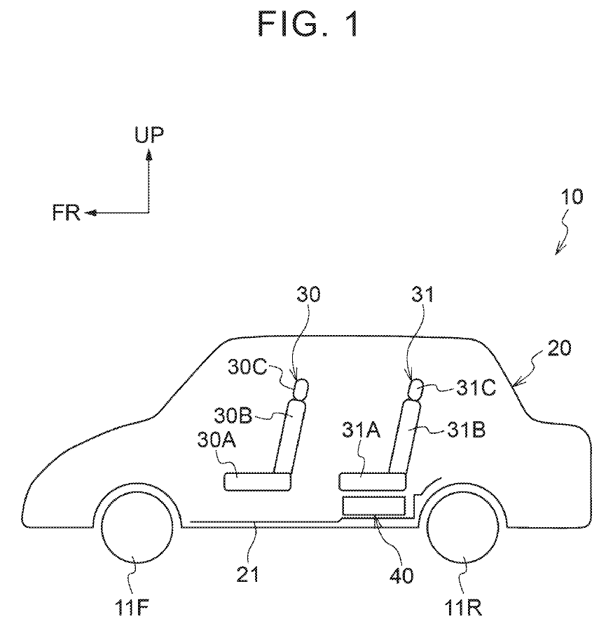

An embodiment of the smoke suppression structure for an energy storage device according to the present disclosure will now be described with reference to FIGS. 1 to 3. In the drawings, the arrow FR indicates the front side in the vehicle front-rear direction, and the arrow UP indicates the upper side in the vehicle up-down direction. In the following description, the terms "front-rear direction," "width direction," and "up-down direction" respectively refer to the vehicle front-rear direction, the vehicle width direction, and the vehicle vertical direction. The term "left-right direction" refers to the left-right direction when facing forward in the vehicle.

### Vehicle

As shown in FIG. 1, the smoke suppression structure for an energy storage device according to the present embodiment is applied to a vehicle 10. The vehicle 10 may be, for example, a hybrid electric vehicle. However, the vehicle to which the smoke suppression structure of the present embodiment is applicable is not limited to hybrid electric vehicles. For example, the smoke suppression structure of the present embodiment may be applied to a battery-powered electrified vehicle or a plug-in hybrid electric vehicle.

The vehicle 10 includes a vehicle body 20 in which a vehicle cabin is provided, a front seat 30 and a rear seat 31 that are installed in the vehicle cabin, and a battery pack (energy storage device) 40 that is installed below the rear seat 31. The vehicle 10 includes an underbody 21 that forms the bottom portion of the vehicle body 20.

The front seat 30 is provided above the underbody 21. The front seat 30 includes a seat cushion 30A on which an occupant sits, a seat back 30B that supports the back of the occupant, and a headrest 30C that supports the head of the occupant. The front seat 30 is disposed such that the body of the seated occupant faces forward in the vehicle. The seat cushion 30A is mounted on a seat frame and is supported from below by the seat frame.

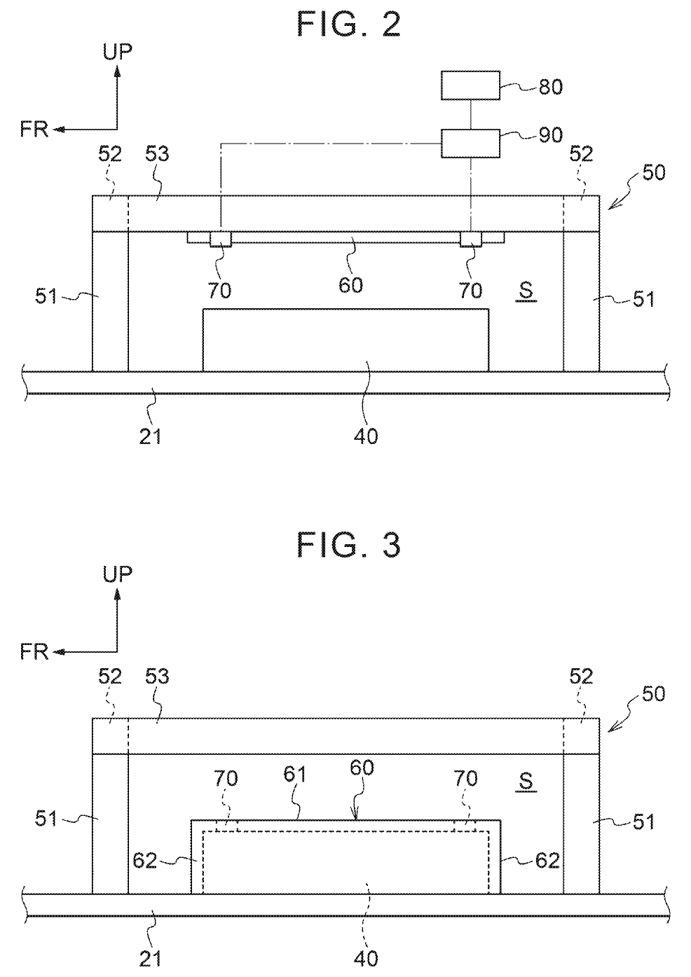

The rear seat 31 is provided above the underbody 21. The rear seat 31 includes a seat cushion 31A on which an occupant sits, a seat back 31B that supports the back of the occupant, and a headrest 31C that supports the head of the occupant. The rear seat 31 is disposed such that the body of the seated occupant faces forward in the vehicle. The seat cushion 31A is mounted on a seat frame 50 (see FIG. 2) and is supported from below by the seat frame 50. For convenience of illustration, the seat frame 50 is omitted in FIG. 1. The seat frame 50 will be described in detail later.

### Smoke Suppression Structure

As shown in FIG. 2, the smoke suppression structure for an energy storage device includes a battery pack (energy storage device) 40, a seat frame (vehicle structural component) 50 that constitutes a part of the vehicle 10, a fire-resistant sheet 60 fixed to the seat frame 50, a plurality of fixing members 70 that fix the fire-resistant sheet 60 to the seat frame 50, a load detection unit 80 that detects a load input to the vehicle 10, and a control unit 90 that controls the fixing members 70.

The battery pack 40 is provided below the seat frame 50. Specifically, the battery pack 40 is disposed in a space S formed between the seat frame 50 and the underbody 21. The space S is an open space with its sides open rather than a sealed space.

The battery pack 40 may be, for example, a lithium battery. The battery pack 40 is configured to be charged and discharged. The battery pack 40 houses a plurality of battery cells inside. Each battery cell houses an electrode assembly and other components within a cell case. Electric power of the battery pack 40 is supplied to, for example, an electric motor (not shown) that provides driving force to front wheels 11F (see FIG. 1) and rear wheels 11R (see FIG. 1) of the vehicle 10.

The seat frame 50 constitutes a part of the vehicle. The seat frame 50 includes a plurality of legs 51 provided on the upper surface of the underbody 21, a pair of first support members 52, each connecting the upper ends of corresponding legs 51 and extending in the vehicle width direction (i.e., in the direction perpendicular to the plane of FIG. 2), and a plurality of second support members 53, each connecting the upper ends of corresponding legs 51 and extending in the vehicle front-rear direction.

The legs 51 extend linearly in the up-down direction. The legs 51 are spaced at predetermined intervals in the vehicle front-rear direction. The legs 51 are also spaced at predetermined intervals in the vehicle width direction.

The first support members 52 extend linearly in the vehicle width direction. Each of the first support members 52 connects legs 51 that are adjacent to each other in the vehicle width direction. The first support members 52 are spaced at a predetermined interval in the vehicle front-rear direction.

The second support members 53 extend linearly in the vehicle front-rear direction. The second support members 53 are spaced at predetermined intervals in the vehicle width direction. The second support members 53 include those that connect legs 51 that are adjacent to each other in the vehicle front-rear direction and those that connect intermediate portions of the first support members 52. The fire-resistant sheet 60 is fixed to the lower surfaces of the second support members 53 by the fixing members 70.

The shape of the seat frame 50 is not limited to the shape described above. For example, the number of legs 51, the number of first support members 52, and the number of second support members 53 are not limited to specific numbers.

The fire-resistant sheet 60 is fixed to the lower surfaces of the second support members 53. The fire-resistant sheet 60 may be fixed in a deployed state so as to span across the second support members 53. The dimensions of the fire-resistant sheet 60 in the vehicle front-rear direction and in the vehicle width direction are greater than the corresponding dimensions of the battery pack 40. The fire-resistant sheet 60 is fixed so as to overlap the entire battery pack 40 as viewed in the up-down direction.

The fire-resistant sheet 60 is formed of a material having excellent heat resistance. The fire-resistant sheet 60 has, for example, heat resistance in the range of about 400°C to about 1500°C. The fire-resistant sheet 60 is configured to block oxygen. The fire-resistant sheet 60 may be formed by, for example, weaving glass fibers, silica fibers, carbon fibers, or the like.

The fire-resistant sheet 60 also has a shape memory function. The fire-resistant sheet 60 is a shape memory sheet that has a memorized shape corresponding to the external shape of the battery pack 40. When the fire-resistant sheet 60 is fixed to the seat frame 50 by the fixing members 70, the fire-resistant sheet 60 is held in a shape different from its memorized shape. Specifically, for example, when the fire-resistant sheet 60 is fixed to the seat frame 50 by the fixing members 70, the fire-resistant sheet 60 is held in the form of a single flat plate.

As shown in FIG. 3, the fire-resistant sheet 60 assumes its memorized shape when it is released from the fixing members 70 and covers the battery pack 40. Specifically, when the fire-resistant sheet 60 is released, it has an upper covering portion 61 that covers the upper surface of the battery pack 40 from above, and side covering portions 62 that cover the front surface, rear surface, and side surfaces (both side surfaces in the vehicle width direction) of the battery pack 40. That is, the fire-resistant sheet 60 has a memorized shape including a first portion (the upper covering portion 61) in the form of a flat shape, and a second portion (the side covering portions 62) that is bent downward from both ends of the first portion in the vehicle front-rear direction and from both ends of the first portion in the vehicle width direction.

As described above, the plurality of fixing members 70 is provided. The fixing members 70 are spaced at predetermined intervals in the vehicle front-rear direction. The fixing members 70 are also spaced at predetermined intervals in the vehicle width direction.

The fixing members 70 fix the fire-resistant sheet 60 to the seat frame 50. The fixing members 70 are fixed to the fire-resistant sheet 60. The fixing members 70 are provided at the front and rear ends of the fire-resistant sheet 60. Each fixing member 70 includes a magnet (not shown) and is fixed to the lower surface of the seat frame 50 by magnetic force of the magnet.

The load detection unit 80 is provided in the vehicle 10. The load detection unit 80 detects a load input to the vehicle 10. For example, the load detection unit 80 detects a load input to the vehicle 10 when the vehicle 10 collides with an object or the like. The load detection unit 80 transmits the detected load to the control unit 90.

The control unit 90 controls the fixing members 70 to release the fire-resistant sheet 60 from the seat frame 50 based on the load detected by the load detection unit 80. For example, when the load detected by the load detection unit 80 is greater than or equal to a predetermined load, the control unit 90 controls the fixing members 70 to release the fire-resistant sheet 60 from the seat frame 50. For example, the control unit 90 transmits a signal to the magnets of the fixing members 70 to reverse the polarity of the magnets, thereby releasing the fixing members 70 from the seat frame 50. The fire-resistant sheet 60 is released from the seat frame 50 in this manner.

### Smoke Suppression Structure

The present embodiment provides the following functions and effects.

The battery pack 40 may generate smoke due to causes such as overcharging, over-discharging, or physical damage. In particular, a lithium battery may generate smoke due to an internal short circuit or thermal runaway.

In the present embodiment, when a predetermined load is input to the vehicle 10, the fixing members 70 that fix the fire-resistant sheet 60 release the fire-resistant sheet 60. Accordingly, when the predetermined load is input to the vehicle 10, the fire-resistant sheet 60 is released and drops downward. Since the fire-resistant sheet 60 is provided above the battery pack 40, the fire-resistant sheet 60 that has dropped covers the battery pack 40 from above (see FIG. 3). Therefore, when a load is input to the vehicle 10, the fire-resistant sheet 60 covers the battery pack 40 and blocks the flow of oxygen toward the battery pack 40. As a result, when a load is input to the vehicle 10, generation of smoke or the like from the battery pack 40 can be suppressed, and the safety of the battery pack 40 can be improved. An example of a case in which a predetermined load is input to the vehicle 10 is when the vehicle 10 collides with an object.

In the present embodiment, the control unit 90 is provided to control the fixing members 70 to release the fire-resistant sheet 60 based on the load detected by the load detection unit 80. Accordingly, when a predetermined load is input to the vehicle 10, the fixing members 70 can release the fire-resistant sheet 60.

In the present embodiment, the fire-resistant sheet 60 is a shape memory sheet that has a memorized shape corresponding to the external shape of the battery pack 40. Accordingly, the fire-resistant sheet 60 can easily cover the battery pack 40. Therefore, oxygen can be more easily blocked from reaching the battery pack 40, and the safety of the battery pack 40 can further be improved.

### Modifications

The above embodiment illustrates an example in which the control unit 90 controls the fixing members 70 to release the fire-resistant sheet 60 based on the load detected by the load detection unit 80. However, the present disclosure is not limited to this example. For example, the fixing members that fix the fire-resistant sheet 60 may be formed of a material that breaks or melts at a predetermined temperature (for example, a resin material). In this case, the load detection unit 80 and the control unit 90 are not provided.

In this modification, the fixing members that fix the fire-resistant sheet 60 are formed of a material that breaks or melts at a predetermined temperature. When the battery pack 40 generates smoke, the smoke generated from the battery pack 40 rises and comes into contact with the fixing members provided above the battery pack 40. When the smoke comes into contact with the fixing members, the temperature of the fixing members rises. When the temperature of the fixing members rises to or above the predetermined temperature, the fixing members melt and can no longer maintain their fixing function. As a result, the fixing members release the fire-resistant sheet, and the fire-resistant sheet drops downward. Since the fire-resistant sheet is provided above the battery pack 40, the fire-resistant sheet that has dropped covers the battery pack 40 from above. The battery pack 40 can thus be covered with the fire-resistant sheet, and the flow of oxygen toward the battery pack 40 can be blocked. Accordingly, even when the battery pack 40 generates smoke, generation of smoke or the like can be suppressed by the fire-resistant sheet 60, and the safety of the battery pack 40 can be improved.

Although the smoke suppression structure for an energy storage device according to the embodiment has been described, various design modifications may be made as appropriate without departing from the spirit and scope of the disclosure.

For example, the above embodiment illustrates an example in which the smoke suppression structure includes the load detection unit 80 that detects a load input to the vehicle 10, and the control unit 90 that controls the fixing members 70 based on the load detected by the load detection unit 80. However, the present disclosure is not limited to this example. For example, the smoke suppression structure may include a temperature detection unit that detects the temperature of the battery pack 40, and a control unit that controls the fixing members 70 based on the temperature detected by the temperature detection unit. In this case, when the temperature of the battery pack 40 detected by the temperature detection unit is higher than or equal to a predetermined temperature, the control unit may determine that the battery pack 40 is generating smoke and release the fixing members 70.

The above embodiment illustrates an example in which the fire-resistant sheet 60 is fixed to the seat frame 50 in a deployed state. However, the present disclosure is not limited to this example. For example, the fire-resistant sheet 60 may be fixed to the seat frame 50 in a folded state. Alternatively, the fire-resistant sheet 60 may be fixed to the seat frame 50 in a rolled state. In this case, the fire-resistant sheet 60 deforms into its memorized shape either while it is dropping toward the battery pack 40 after being released from the fixing members 70, or after it drops onto the battery pack 40. Specifically, the fire-resistant sheet 60 deforms into a shape that covers the battery pack 40 and covers the battery pack 40 from above. The size of the fire-resistant sheet 60 in its fixed state can be reduced by fixing the fire-resistant sheet 60 to the seat frame 50 in a folded state or a rolled state. Therefore, the installation space for the fire-resistant sheet can be reduced.

The above embodiment illustrates an example in which the fire-resistant sheet 60 is released from the seat frame 50 by releasing the fixing members 70 from the seat frame 50. However, the present disclosure is not limited to this example. Alternatively, the fire-resistant sheet 60 may be released from the seat frame 50 by releasing the fire-resistant sheet 60 from the fixing members 70. In this case, when the fire-resistant sheet 60 is released from the seat frame 50, the fixing members 70 remain fixed to the seat frame 50, and the fire-resistant sheet 60 drops independently onto the battery pack 40.

What is claimed is:

1. A smoke suppression structure for an energy storage device, the smoke suppression structure comprising:
a vehicle structural component that constitutes a part of a vehicle;
an energy storage device provided below the vehicle structural component;
a fire-resistant sheet fixed to the vehicle structural component and provided above the energy storage device; and
a fixing member that fixes the fire-resistant sheet to the vehicle structural component,
wherein the fixing member is configured to release the fire-resistant sheet from the vehicle structural component when a predetermined load is input to the vehicle.

2. The smoke suppression structure according to claim 1, further comprising:
a load detection unit configured to detect a load input to the vehicle; and
a control unit configured to control the fixing member to release the fire-resistant sheet from the vehicle structural component based on the load detected by the load detection unit.

3. A smoke suppression structure for an energy storage device, the smoke suppression structure comprising:
a vehicle structural component that constitutes a part of a vehicle;
an energy storage device provided below the vehicle structural component;
a fire-resistant sheet fixed to the vehicle structural component and provided above the energy storage device; and
a fixing member that fixes the fire-resistant sheet to the vehicle structural component,
wherein the fixing member is configured to release the fire-resistant sheet from the vehicle structural component when the fixing member reaches a predetermined temperature or higher.

4. The smoke suppression structure according to claim 1, wherein the fire-resistant sheet is a shape memory sheet that has a memorized shape corresponding to an external shape of the energy storage device.

5. The smoke suppression structure according to claim 3, wherein the fire-resistant sheet is a shape memory sheet that has a memorized shape corresponding to an external shape of the energy storage device.
